(19) United States
(12) Patent Application Publication
(10) Pub. No.: US 2004/0018041 A1
(43) Pub. Date: Jan. 29, 2004

(54) Plurality of binding elements for automated processes

(76) Inventors: Samuel Amdahl, Des Plaines, IL (US); Thomas Battisti, Buffalo Grove, IL (US); Jacob Greenberg, Rolling Meadows, IL (US); Wayne Rothschild, Northbrook, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/432,459

(22) PCT Filed: Nov. 20, 2001
(86) PCT No.: PCT/US01/43252

(51) Int. Cl. B42F 13/00

(52) U.S. Cl. 402/26

(57) ABSTRACT

The invention includes binding elements (30) which are coupled together by coupling structure (22) to facilitate storage and automated feeding, handling and/or binding operations. The coupling structure (22) may be in the form of, for example, extraneous structure such as a cartridge or runners disposed between the individual elements, the coupling structure (22) may be in the form of a continuous length of binding element (30) itself. Extraneous coupling structure (22), such as runners are severed from the binding elements (30), or the continuous length of binding elements is cut to size either before, during, or after the feeding, handling and binding operations. Extraneous coupling structure (22) may also be attached to the binding elements (30) by way of a flexible connector which provides a degree of tolerance in the relative positions of the binding element and the coupling structure or other structure used to feed the elements into an automated process.

### FIELD OF THE INVENTION

The present invention relates to binding elements for holding a plurality of perforated sheets or the like, and more specifically the invention pertains to structure for coupling binding elements for use in automated binding processes.

### BACKGROUND OF THE INVENTION

Various types of binding elements have been utilized to bind a stack of perforated sheets or the like. Examples of such binding elements which are of a wire comb or hanger-type design are disclosed, for example, in U.S. Pat. No. 2,112,389 to Trussell and U.S. Pat. Nos. 4,832,370 and 4,873,858 to Jones, while machines for assembling such binders are disclosed in U.S. Pat. No. 4,031,585 to Adams, U.S. Pat. No. 4,398,856 to Archer et al., U.S. Pat. No. 4,525,117 to Jones, U.S. Pat. No. 4,934,890 to Flatt, and U.S. Pat. No. 5,370,489 to Bagroky. Other binding devices are disclosed, for example, in the following references: U.S. Pat. Nos. 2,089,881 and 2,363,848 to Emmer, U.S. Pat. No. 2,435,848 to Schade, U.S. Pat. No. 2,466,451 to Liebman, U.S. Pat. No. 4,607,970 to Heusenkveld, U.S. Pat. No. 4,904,103 to Im, U.S. Pat. No. 5,028,159 to Amrich et al., U.S. Pat. No. 4,369,013, Reexamination Certificate B1 4,369,013 and Re. 28,202 to Abildgaard et al. Machines for assembling plastic comb or finger binding elements are disclosed in patents such as U.S. Pat. Nos. 4,645,399 to Scharer, U.S. Pat. No. 4,900,211 to Vercillo, U.S. Pat. No. 5,090,859 to Nanos et al., and U.S. Pat. No. 5,464,312 to Hotkowski et al. The patents are included herein by reference.

Binding elements typically include a spine from which a plurality of fingers extend which may be assembled through perforations in a stack of sheets. This spine may be linear, with or without a longitudinally extending hinge. Alternately, the spine may be formed by sequential bending of a wire, as with wire comb or hanger type binding elements.

Due to the structure of such binding devices, which include elongated spines and fingers, the binding devices commonly become entangled when stored in a group. Detangling the binding elements in order to assemble the element to a stack of sheets or lay the element into a binding machine can be a tedious and potentially time consuming process. Further, this tendency to become entangled may complicate or prevent the use of such binding devices in automated binding processes or machines wherein an automated feed is desirable. The time required to manually feed binding elements into a machine would be prohibitive to efficient, high-volume automated binding operations.

### OBJECTS OF THE INVENTION

It is a primary object of the invention to provide a plurality of binding elements which may be readily utilized in automated feeding into a binding machine and are resistant to tangling.

Another object of the invention is to provide a coupled group of binding elements in which the coupling structure does not interfere with the use or final appearance of a binding element. A related object is to provide a plurality of binding elements having a coupling structure which may be severed from the binding element during an automated binding process.

An additional object of the invention is to provide a plurality of binding devices which may be economically and efficiently manufactured.

A further object is to provide a coupled group of binding elements which may be molded using conventional molding techniques.

These and other objects and advantages of the invention will be apparent to those skilled in the art upon reading the following summary and detailed description and upon reference to the drawings.

### BRIEF SUMMARY OF THE INVENTION

The invention provides a plurality of binding elements that are particularly suitable for usage in automated binding processes. According to a first embodiment of the invention, a continuous elongated binding element is provided which may be either rolled into a flat roll or along a spool. In use, the continuous binding element, which is, in actuality, a plurality of coupled individual binding elements, may be fed into an automated machine, and individual binding elements cut to a desired length.

The continuous binding elements may be manufactured by any appropriate method, but the currently preferred method includes molding a length of one or more binding elements in a mold, demolding the molded elements, and advancing the molded element into a position within or adjacent the mold cavities and molding a connected binding element. In so molding the elements, the trailing portion of the binding element may be only partially molded, and the partially molded trailing section of the binding element advanced to the lead end cavities of the mold to mold on the next section of continuous binding element, completing the partially molded trailing end of the first formed binding element. Alternately, an extruded strip or other spine element may be placed into the mold and fingers consecutively molded along the continuous spine.

Alternately, a plurality of binding elements may be coupled together with runners disposed at the longitudinal ends of the spines of the strips. A plurality of binding elements in this form may be provided either as discrete sheets, or as a continuous sheet which is rolled up in a manner similar to the continuously molded binding elements described above. As with the single continuous binding element described above, the continuous sheet may be molded by a partial molding in the trailing cavity; which is then advanced to the lead cavity. Alternately, an extruded or otherwise manufactured strip may be used as the continuous runner at the longitudinal ends of the plurality of binding elements. In another embodiment, the runners may be in the form of a number of discrete links that extend between fingers or other portion of adjacent binding elements.

Further, the coupling structure may include more than one coupling structure. For example, in addition to runners, the plurality of binding elements may include stacking or nesting structure such as is disclosed in P.C.T. Application PCT/US0106362, filed Feb. 28, 2001, based upon U.S. Provisional Application No. 60/188372, which was invented by one of the named inventors in this application and is assigned to the assignee of this application. P.C.T. Application PCT/US0106362 is hereby incorporated herein by reference for all that it discloses. The nesting elements may be disposed in board or outboard the runners. In use, the nesting structure may be used to stack sheets of binding elements coupled by runners. Alternately, if only one of the coupling or nesting structure is utilized in the storage, feeding and/or assembly processes, the unused structure may simply be severed prior to the process, or may remain as a superfluous structure that is severed with the other coupling or nesting structure following the storage, feeding and/or assembly processes.

In yet another embodiment of the invention, the sheets of binding elements coupled by runners (with or without stacking structure) at the longitudinal ends or discrete binding elements (with or without stacking structure) may be disposed in a feeding structure, such as a flat box, cassette, or cartridge arrangement having a section which is open for feeding the contained elements into a continuous binding process.

A small spring is preferably molded between a binding element and the coupling structure and/or the stacking structure. The small spring may be molded integrally with the element, and provides a degree of flexibility between the element itself and the feeding or assembly machine components. Thus, the incorporation of such springs serves to eliminate or minimize any adverse effects of variances effecting the tolerances between the molded part and the mechanized handling structure, such as variances in the shrinkage of the plastic parts during the molding process.

These and other objects and advantages of the invention will be apparent to those skilled in the art upon reading the following summary and detailed description and upon reference to the drawings.

### BRIEF DESCRIPTION OF THE DRAWINGS

FIG. 1 is a perspective view of a binding element of the prior art.

FIG. 2 is a plurality of binding elements constructed in accordance with teachings of the invention.

FIG. 3 is a second embodiment of a plurality of binding elements constructed in accordance with teachings of the invention.

FIG. 4 is a perspective view of a mold for molding binding elements constructed in accordance with teachings of the invention, such as those illustrated in FIGS. 2 and 3.

FIG. 5 is an enlarged fragmentary perspective view of the trailing end of the mold of FIG. 4, along with a fragmentary perspective view of a molded binding element.

FIG. 6 is an enlarged fragmentary view of the leading end of the mold of FIG. 4, along with a fragmentary perspective view of a trailing end of a binding element constructed in accordance with teachings of the invention.

FIG. 7 is a perspective view of a mold of a second method of molding binding elements in accordance with teachings of the invention.

FIG. 8 is a perspective view of a fourth embodiment of a plurality of binding units constructed in accordance with teachings of the invention.

FIG. 9 is a perspective view of a fifth embodiment of a plurality of binding units constructed in accordance with teachings of the invention.

FIG. 10 is a perspective view of a sixth embodiment of a plurality of binding units constructed in accordance with teachings of the invention.

FIG. 11A is a perspective view of a binding element including a stacking structure.

FIG. 11B is a perspective view of the opposite side of the binding element of FIG. 11A.

FIG. 11C is an enlarged end view of the binding element of FIGS. 11A and B.

FIG. 12 is a perspective view of a seventh embodiment of a plurality of binding units constructed in accordance with teachings of the invention.

FIG. 13 is a perspective view of an eighth embodiment of a plurality of binding units constructed in accordance with teachings of the invention.

FIG. 14 is an enlarged fragmentary perspective view of a ninth embodiment of a plurality of binding units constructed in accordance with teachings of the invention.

FIG. 15 is a perspective view of a tenth embodiment of a plurality of binding units constructed in accordance with teachings of the invention.

FIG. 16 is a perspective view of an eleventh embodiment of a plurality of binding units constructed in accordance with teachings of the invention.

FIG. 17 is a fragmentary side elevational view of a single binding unit a twelfth embodiment a plurality of binding units constructed in accordance with teachings of the invention.

FIG. 18 is an enlarged cross-sectional view of the stacking cap taken along line 18-18 in FIG. 17.

FIG. 19 is a fragmentary plan view of the plurality of binding units taken along line 19-19 in FIG. 17.

FIG. 20 is a perspective view of a thirteenth embodiment of a plurality of binding units constructed in accordance with teachings of the invention.

FIG. 21 in an enlarged fragmentary view of end sections of the binding units shown in FIG. 20.

### DETAILED DESCRIPTION OF THE INVENTION

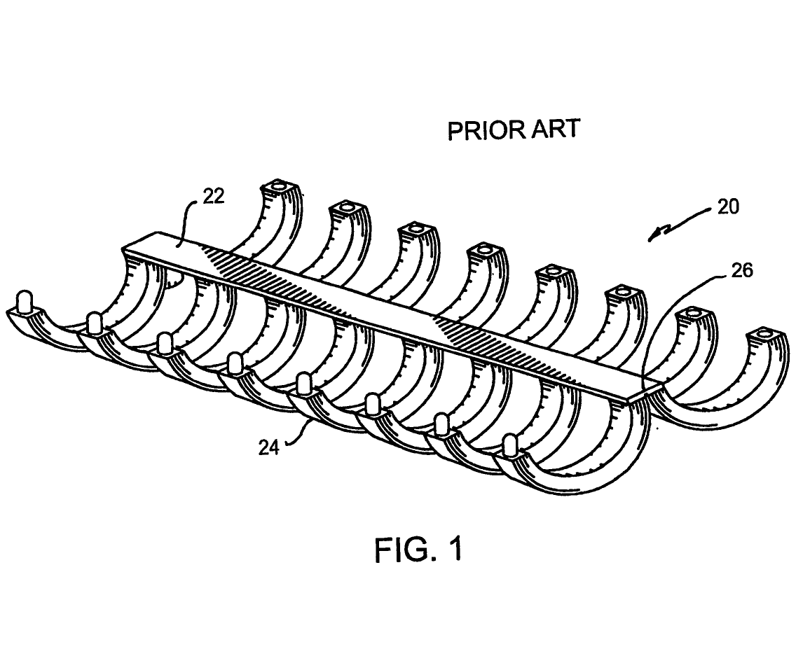

Turning now to the drawings, there is shown in FIG. 1 a typical binding element 20 which includes a spine 22 and a plurality of fingers 24 which protrude from either side of the spine 22. The spine may further include a living hinge 26 or the like, which facilitates the bending of the fingers 24 toward one another. In this way, the fingers may be inserted through perforations in a stack of sheets (not shown) to bind the sheets together. In the embodiment illustrated, the living hinge 26 is in the form of a longitudinally extending line of reduced thickness along the spine. Binding elements of this type are disclosed in U.S. Pat. No. 6,270,280, which will issue Aug. 7, 2001 and which is incorporated herein by reference for all it discloses.

In accordance with the invention, the binder 20 is provided as part of a plurality of binding elements disposed in predetermined adjacent spacial relationships relative to one another to facilitate automated binding processes. It will be appreciated that the term “adjacent” as used here includes not only binding elements that are disposed very closely, but binding elements that are spaced away from each other as well, so long as the spacial relationship is maintained. A plurality of elements so disposed may be readily handled without becoming tangled and may be coupled to an automated binding machine (not shown) for use in high volume binding processes. A coupling structure between the plurality of binders 20 is then typically sheared or sheared off to separate the elements before, during or after the handling process, the closing process, and/or the binding process. Alternately, if the coupling structure is in the form of a cartridge or the like, the cartridge may be discarded or recycled for later use.

It will be appreciated by those of skill in the art that the particular design of the binding elements 20 themselves may be of an alternate configuration than those disclosed in the illustrations herein. For example, the binding elements may include single as opposed to pairs of fingers which extend from the spine. Preferably, however, the binding elements 20 are of a design which may be readily molded from plastic by processes, such as, injection molding. Examples of other sheet binding element structures are illustrated, for example, in U.S. Pat. No. 4,369,013 to Abildgaard et al., U.S. Pat. No. 4,607,970 to Heusenkveld, U.S. Pat. No. 4,873,858 to Jones, U.S. Pat. No. 4,900,211 to Vercillo, U.S. Pat. No. 4,904,103 to Im, and U.S. Pat. No. 5,028,159 to Amrich et al.

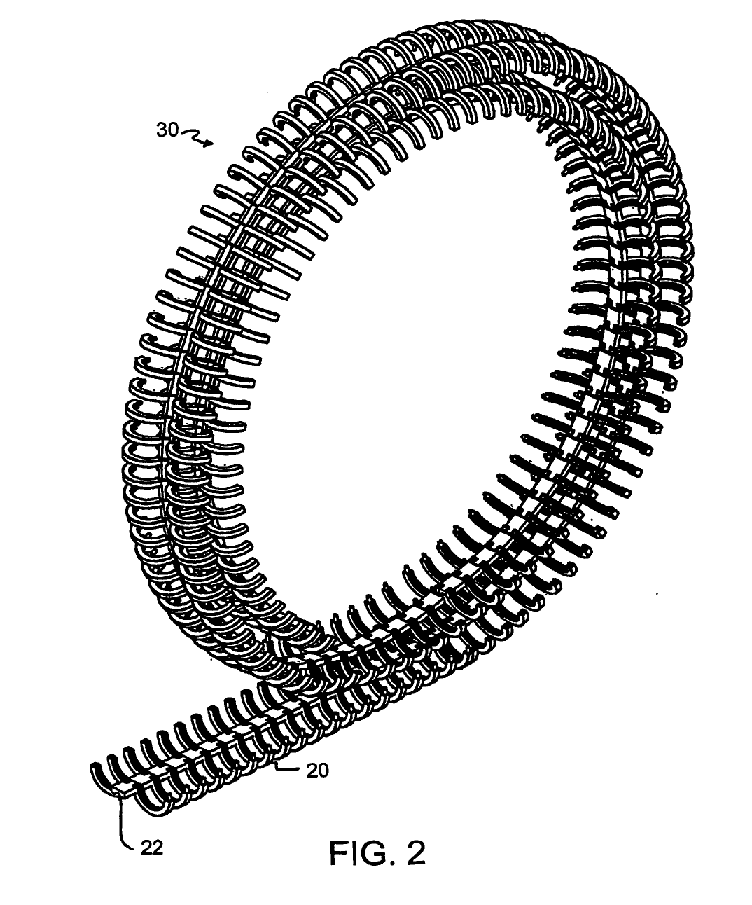

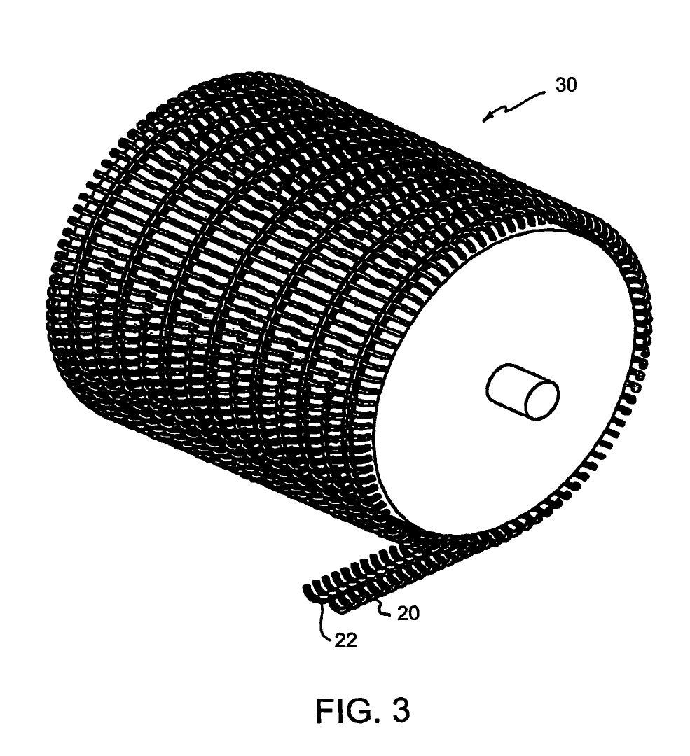

Turning now to FIG. 2, there is illustrated a first embodiment of a plurality of binding elements 30 constructed in accordance with teachings of the invention. While appearing to resemble a continuous binding element, the plurality of binding elements 30 illustrated in FIG. 2 is essentially a series of binding elements 20 molded end-to-end. The elongated strip of the plurality of binding elements 30 may be rolled up in any appropriate manner, such as the flat roll illustrated in FIG. 2 or the spooled roll shown in FIG. 3. The plurality of binding elements 30 may then be rolled out to a flat position and a binding element 20 of a desired length cut from the unrolled strip. It will be appreciated that in this embodiment the elongated spine 22 itself is the coupling structure between the individual binding elements 20. In this way, this embodiment is particularly useful in that the plurality of binding elements 30 may be utilized in arrangements for binding various lengths of stacks of sheets.

While the spine 22 may be of a substantially uniform cross-section, it will be appreciated that the elongated length of spine 22 running through the plurality of binding elements 30 may alternately include variances in the cross section at intervals along the length of the spine 22 of the plurality of binding elements 30. For example, the spine 22 may have a reduced size cross-section at standard lengths, such as 8-½ inches, 11 inches, or 14 inches which could facilitate severing the adjacent binding elements.

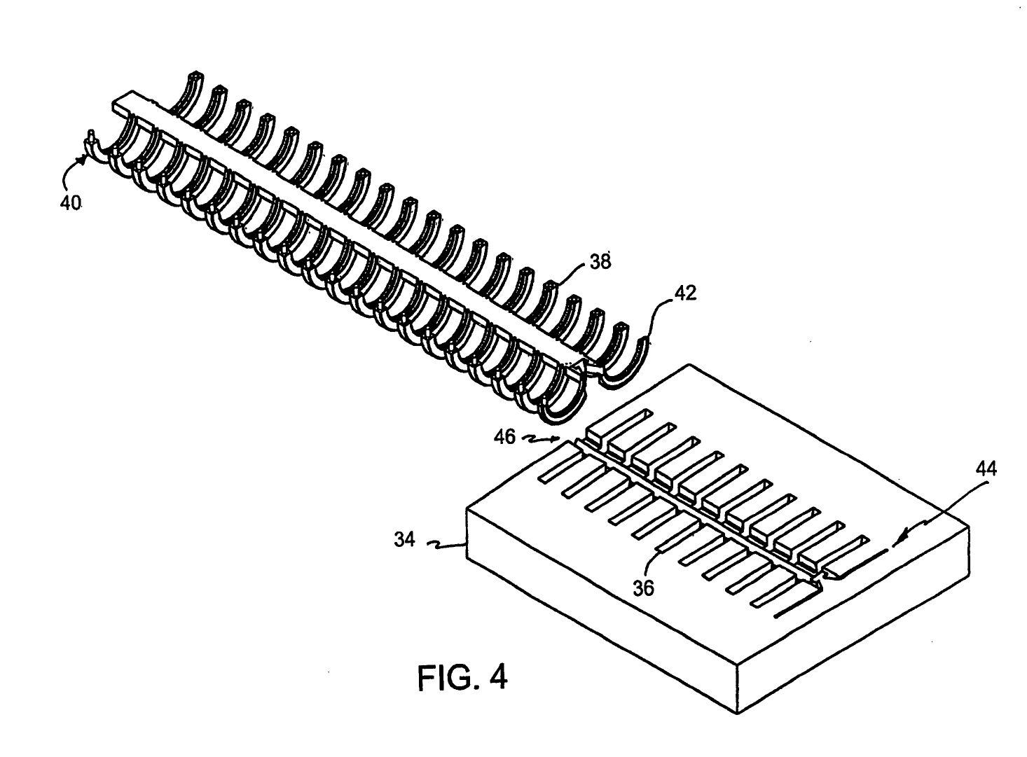

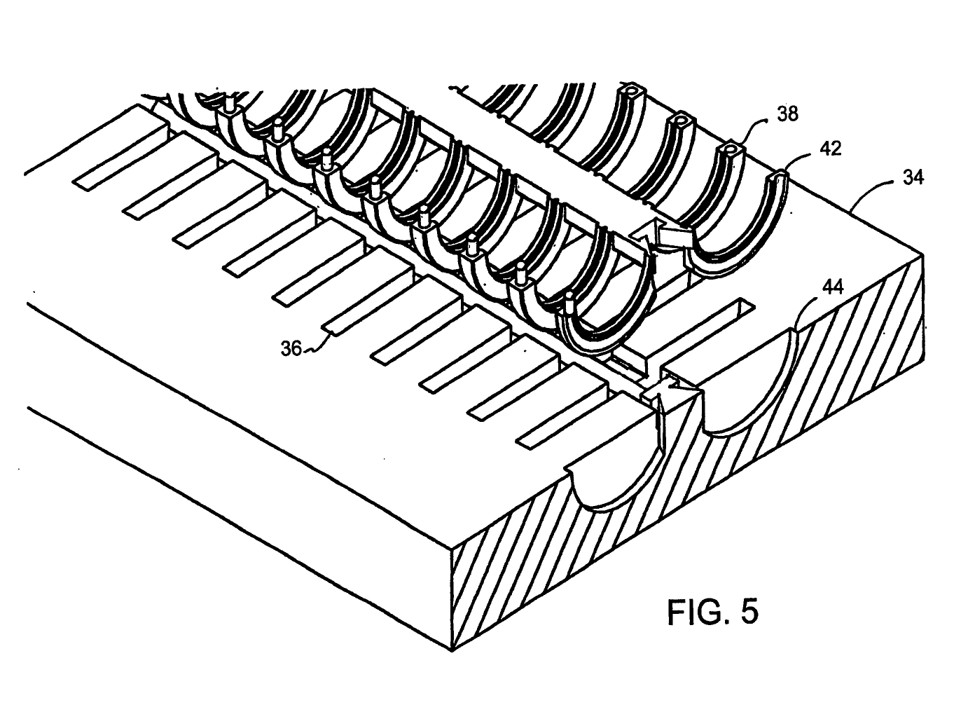

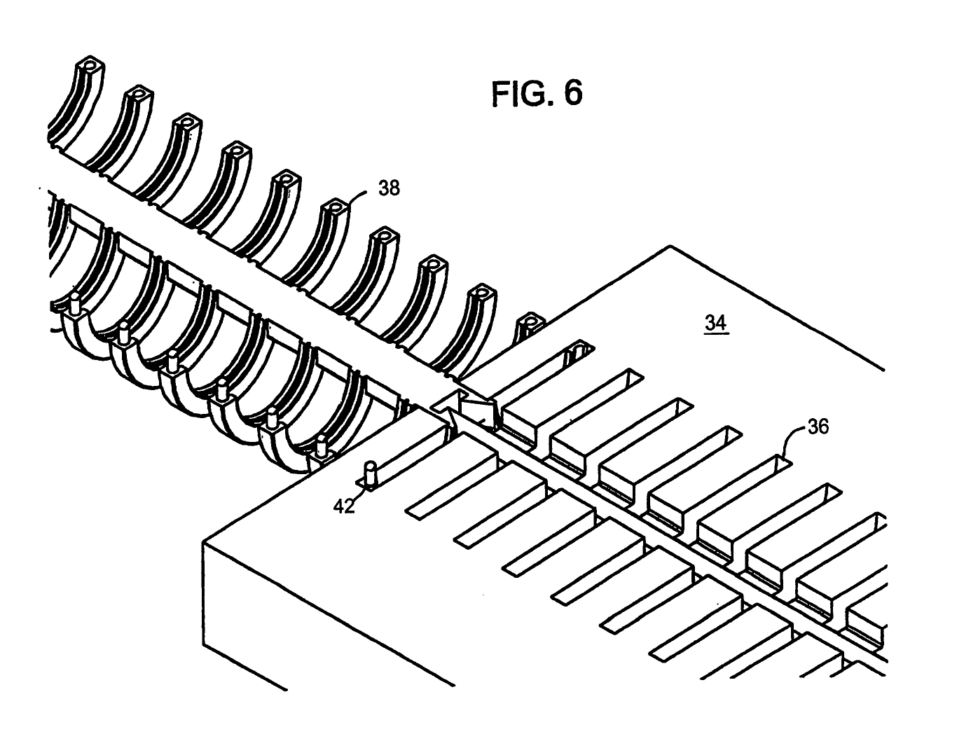

One method of molding the continuous plurality of binding elements (as shown in FIGS. 2 and 3) is within the mold illustrated in FIG. 4. According to this method, the mold 34 (the bottom half of the mold is illustrated in the figures) is provided with a cavity 36 for molding a length of binding element 38 having a lead end 40 and a trailing end 42. According to an important aspect of this method, the portion of the mold cavity 44 in which the trailing end 42 is molded is designed to mold only a portion of the trailing end 42 (see FIG. 5). In the embodiment illustrated, only a portion of the trailing end fingers and trailing end spine are molded in the trailing end 44 of the mold cavity. In this way, after a length of binding element 38 is molded, the molded length 38 is removed from the mold and advanced to a position where the trailing end 42 of the length of binding element 38 is disposed in the cavity 36 at the lead end 46 of the mold (see FIG. 6). During the following molding cycle, a second length of binding element is molded, and the trailing end 42 of the previous element length 38 becomes the lead end 40 of the second molded length of binding element, the molding of the second length completing the spine and fingers at the trailing end 42 of the first length of binding element 38. In this way, a continuous length of strip, or plurality of binding elements 30, may be molded as a continuous piece.

Preferably, the partial molding of the trailing end 42 of the molded length 38 is such that it causes an engagement with the subsequently molded length 38, as shown, for example, in FIGS. 5 and 6. While the illustrated embodiment includes a partially molded trailing set of finger elements and a partially molded engaging spine, it will be appreciated that alternate arrangements may be used. For example, the trailing set of fingers could be completely molded, and the spine only partially molded with a structure that facilitates molding the next section of spine thereto. It is expected that a dovetail arrangement of the spine, shown in FIGS. 4-6, even without the partial molding of the trailing set of fingers would be sufficient to supply a firm attachment of a subsequently molded length of binding strip. Alternately, however, the partial molding may be very simple in design, as, for example, with one-half of the spine and one-half of the fingers at the trailing end 42 being molded in the initial mold cycle.

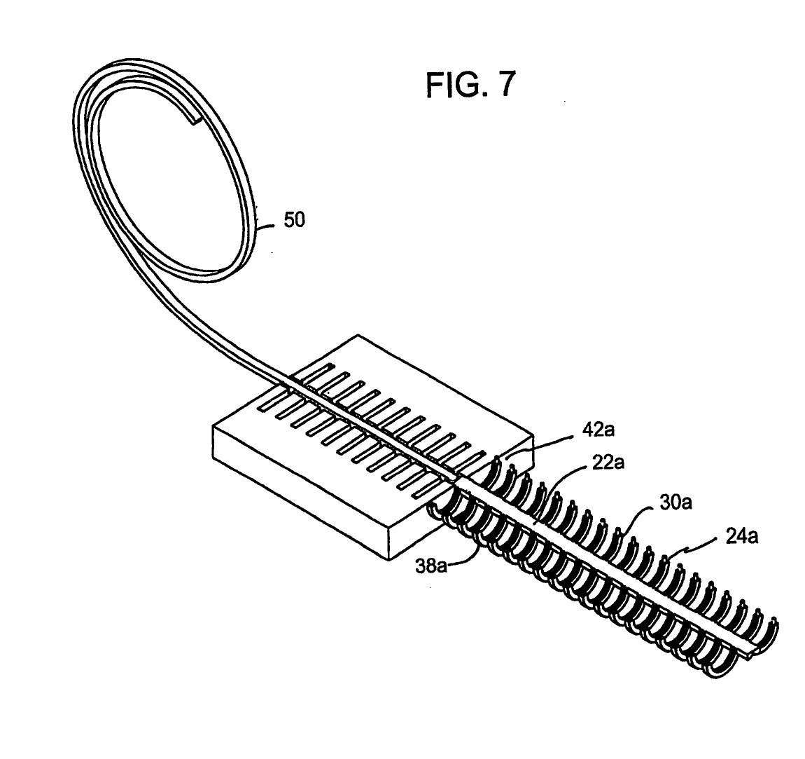

A second method of molding the continuous length of binding elements 30a is by molding fingers 24a to a previously formed continuous strip 50 disposed along the spine area, as in the arrangement illustrated in FIG. 7. According to this method, all of the fingers of a molded length of binding element 38a are typically completely formed, rather than only partially forming the trailing end 42a of the strip. The strip 50 may be formed of any appropriate material such as, for example, fabric, metal, or an extruded plastic or polymeric material. For the purposes of this invention, the term cord is intended to include fabric, thread or string, rope, or the like, and the term wire is intended to include metal wire, filament, or thin flat sheet. While a relatively large rectangular continuous strip 50 is shown in FIG. 7, it will be appreciated that the continuous strip 50 may be of an alternate thickness, width, and shape, so long as it provides a continuous element to which the length of strip may be molded. For example, the continuous strip 50 may be a thin cord, and the fingers along with the bulk of the spine 22a may be molded to the cord to form the continuous length of strip.

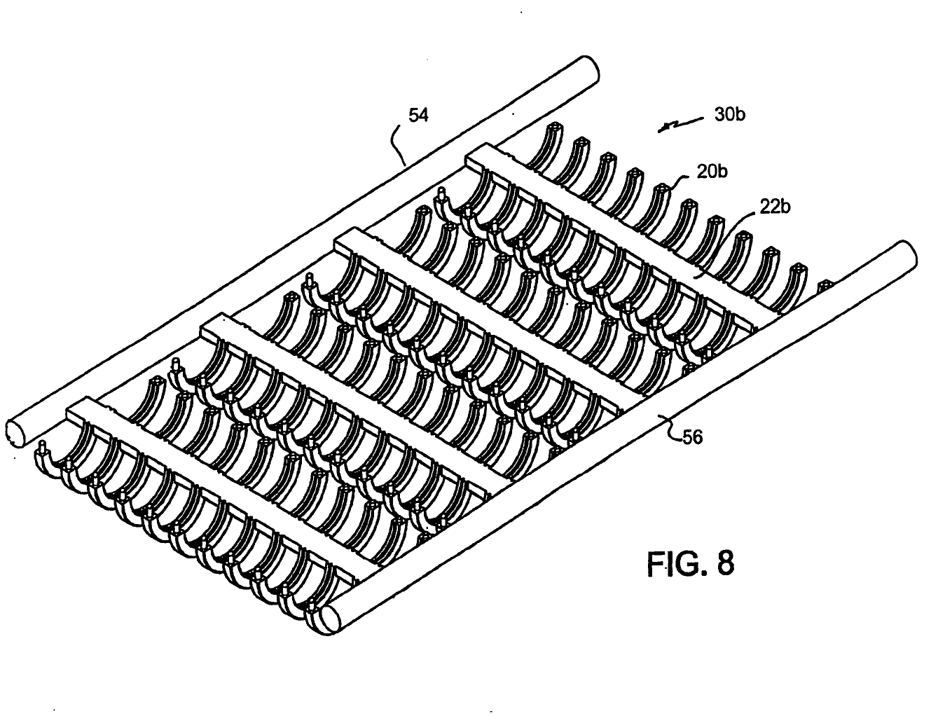

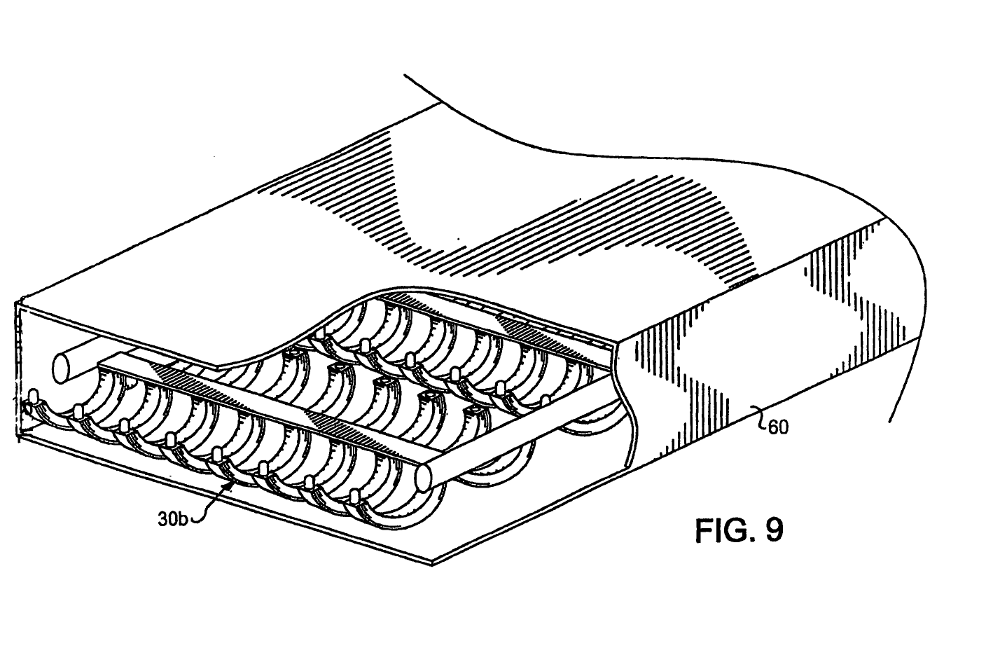

Turning now to FIG. 8, there is shown another embodiment of a plurality of binding elements 30b. In this embodiment, a sheet of parallel binding elements 20b are simultaneously molded with runners 54, 56 coupling together the binding elements 20b along the opposite longitudinal ends of the spines 22b. In this way, the plurality of binding elements 30b may be fed to a binding machine to bind stacks of sheets. The plurality of elements 30b may be fed directly into a machine as shown, for example, in FIG. 8, or the plurality of elements 30b may be disposed in a feeding structure, such as the box 60 shown in FIG. 9. In this way, the runners 54, 56 may be utilized in the feeding process or engage structure within the binding or feeding machine (not shown).

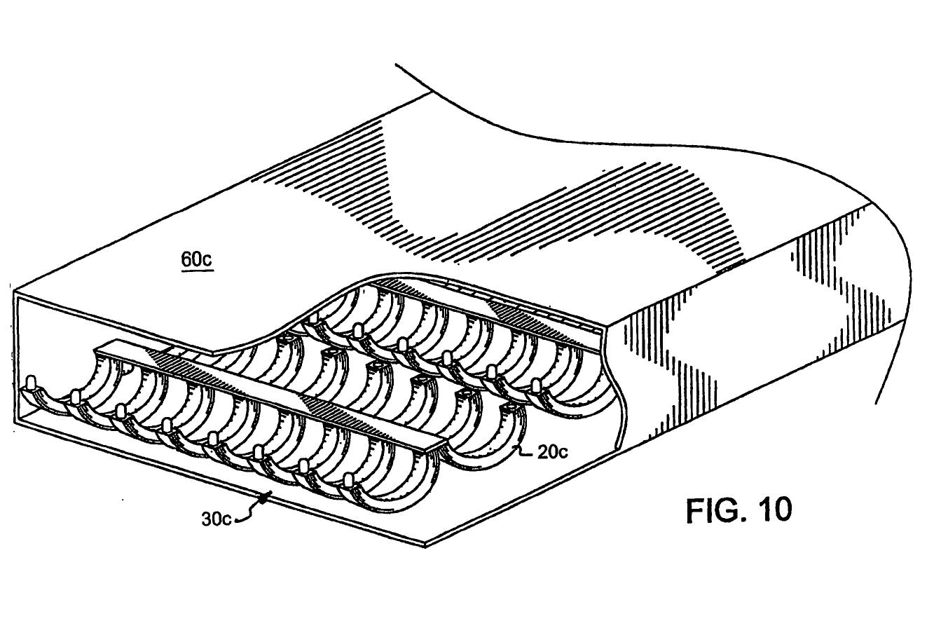

Alternately, individual binding elements 20c may be disposed within such a feeding structure or cartridge 60c. The building elements 20c may be individual elements 20c which are essentially in the form that the binding elements 20c take in the final bound stack of sheets, such as shown in FIG. 10, or the binding elements 20h may include a stacking or spacing structure 70, such as disclosed, for example, in Application PCT/US01/06362, which is assigned to the assignee of this application. The disclosure of Application PCT/US01/06362 is incorporated herein by reference in its entirety for its disclosure with regard to the stacking structure, its possible designs, and the manner in which the stacking structures may cooperate during stacking.

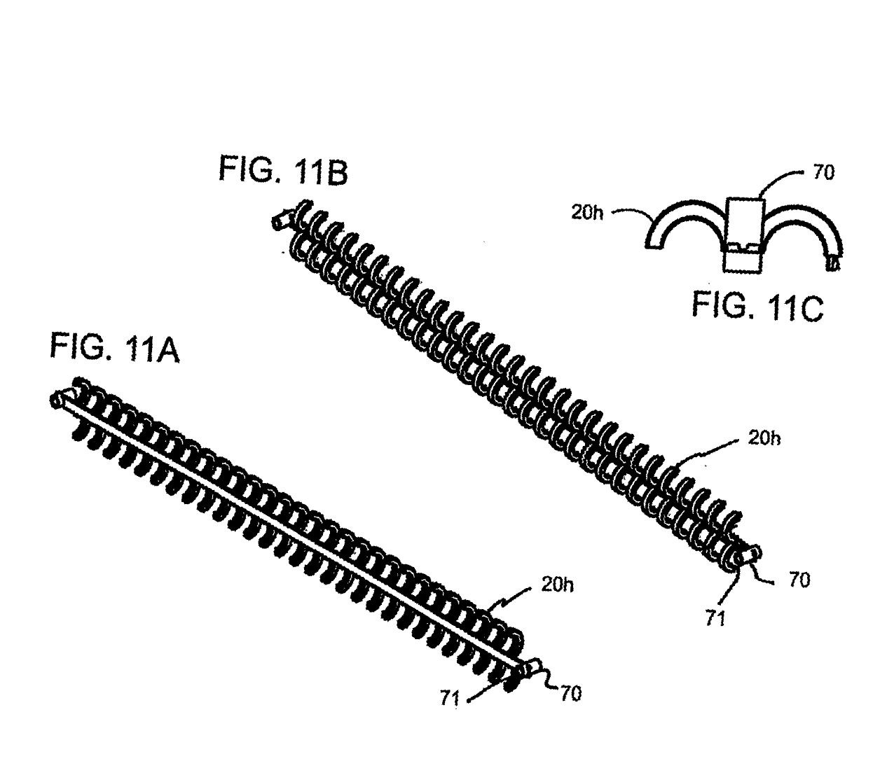

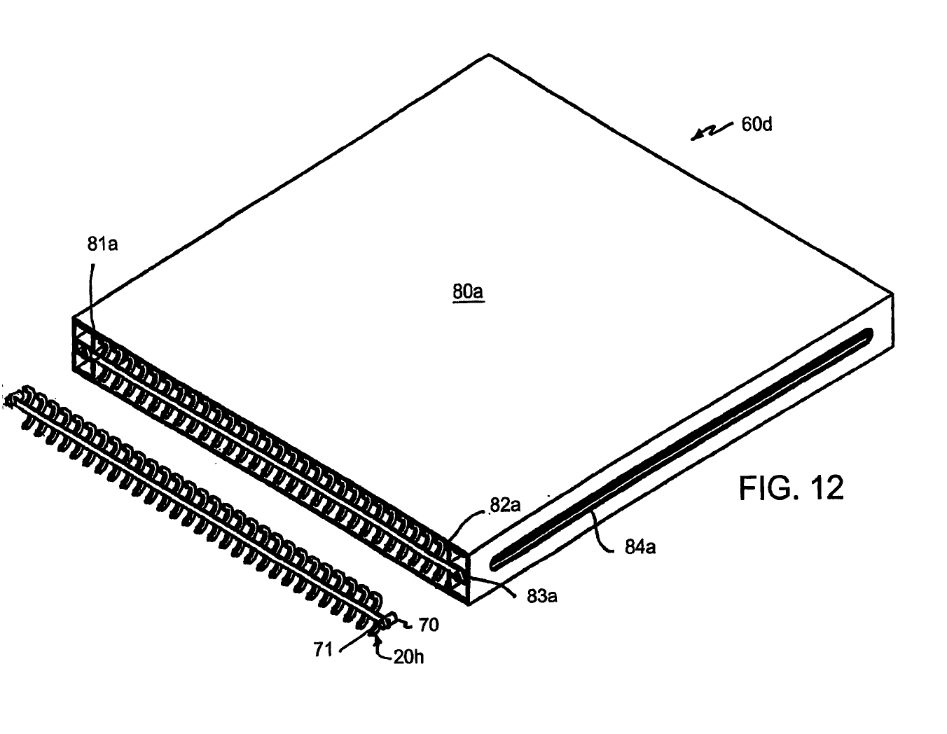

In the currently preferred embodiments illustrated in FIGS. 12-14, a plurality of binding elements 20h shown in FIGS. 11A through 11C is disposed in various cartridge designs, 60d, 60e, 60f. The binding elements 20h include stacking structure 70, which has a generally cylindrical shape. As disposed in the cartridges 60d, 60e, 60f, the stacking structures 70 merely abut one another to maintain the relative positions of the binding elements 20h. Accordingly, the stacking structure may have any appropriate design which maintains the elements 20h in their respective spaced locations. It will be appreciated that the bore 71 extending through the center of each stacking structures 70 may be used to facilitate an automated placement of the binding elements. 20h within the cartridges 60d, 60e, 60f, as by receiving a probe or the like (not shown) which may be utilized to efficiently load the binding elements 20h into the cartridges. Further, the stacking structures 70 themselves may be sized such that the cross-section or the length of the stacking structure 70 provides an indication of the size of the binding element itself, e.g., the final closed diameter of the binding element 20h.

While the cartridges 60a, 60b, 60c of FIGS. 12-14 are each designed to contain a different number of layers of binding elements 20h, the cartridges 60d, 60e, 60f have some similar features, including a shell 80a, 80b, 80c defining a hollow interior in which the binding strips 20h are stored and an opening 81a, 81b, 81c through which the strips 20h are dispensed to a machine (not shown). Although the shells of the illustrated embodiment include walls, the shell may be in the form of a frame-type arrangement likewise defining a hollow interior in which the binding strips are stored. In order to ensure proper movement of the binding elements 20h within the cartridge 60a, 60b, 60c, each layer 82a, 82b, 82c is provided with a channel or guide rails 83a, 83b, 83c along which the aligned group of stacking structures 70 is disposed. It will thus be appreciated that the binding elements 20h will be held in a given orientation and will not typically be able to tilt or rotate, ensuring consistent and accurate delivery to an automated binding machine.

In order to allow for mechanical advancement of the binding strips 20h of a given layer 82a, 82b, the cartridge 60d, 60e may be provided with one or more access slots 84a, 84b. The access slots 84a, 84b may be used both to visually determine the number of binding elements 20h contained in the cartridge 60d, 60e, and to access the respective stacking structure 70 of the strips 20h themselves. In this way, an element of the binding or handling machine (not shown) may access the plurality of binding strips 20h via the access slot(s) 84a, 84b to move them forward through the cartridge 60d, 60e by asserting a force on the associated stacking structure 70.

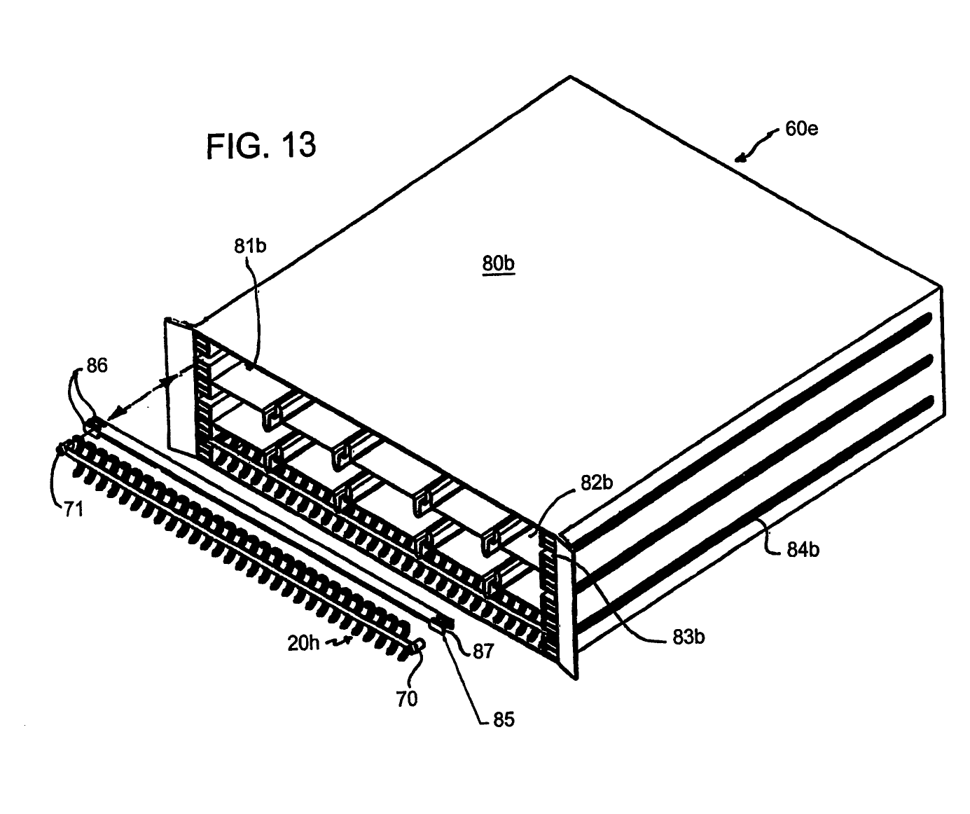

As shown in FIG. 13, the cartridge 60e may further include a drive bar 85, which may be disposed within the cooperating channels or guide rails 83b of a given layer “behind” the stack of binding elements 20h. In the embodiment illustrated, the opposite ends of the drive bar 85 include flexible fingers 86. It will be appreciated that a mechanical element of a binding or handling machine may readily engage a thrust surface 87 of the flexible fingers 86 in order to advance the stack of binding elements 20h through the channels in the cartridge 60e. Additionally, the flexible fingers 86 prevent the drive bar 85 and, accordingly, the stack of binding elements 20h from sliding back into the cartridge 60e, i.e., the binding elements 20h are biased toward the opening. Alternately, or additionally, the lower surface of the channel or guide rail 83b, and/or the fingers 86 of the drive bar 85 may have an increased frictional resistance to movement of the strips 20h or the drive bar 85. According to another embodiment, a ratcheting arrangement of the strips 20h and/or drive bar 85 may be provided which prevents the strips 20h from retreating into the cartridge 60d, 60e, 60f.

Referring again to FIG. 13, the cartridge 60e may also be provided with a surface which prevents the binding strips 20h from being removed from the cartridge 60c when it is not engaged with the handling or binding machine. In this regard, a restraining device in the form of one or more covers, doors, flanges, or straps, for example, may be provided. While the cover(s) or door(s) 87, such as are shown in FIG. 13, may be sized to cover the entire opening 81b, it is only necessary that they be sized to prevent the binding strips 20h from escaping the cartridge 60e. In the illustrated embodiment, elongated pivoting doors 87 are provided at either side of the opening 81b of the cartridge 60e. It will thus be appreciated that the doors 87 cover only the channels 83b in which the stacking structures 70 of the binding strips 20h are disposed, restraining the ends and therefore the entire binding strips 20h.

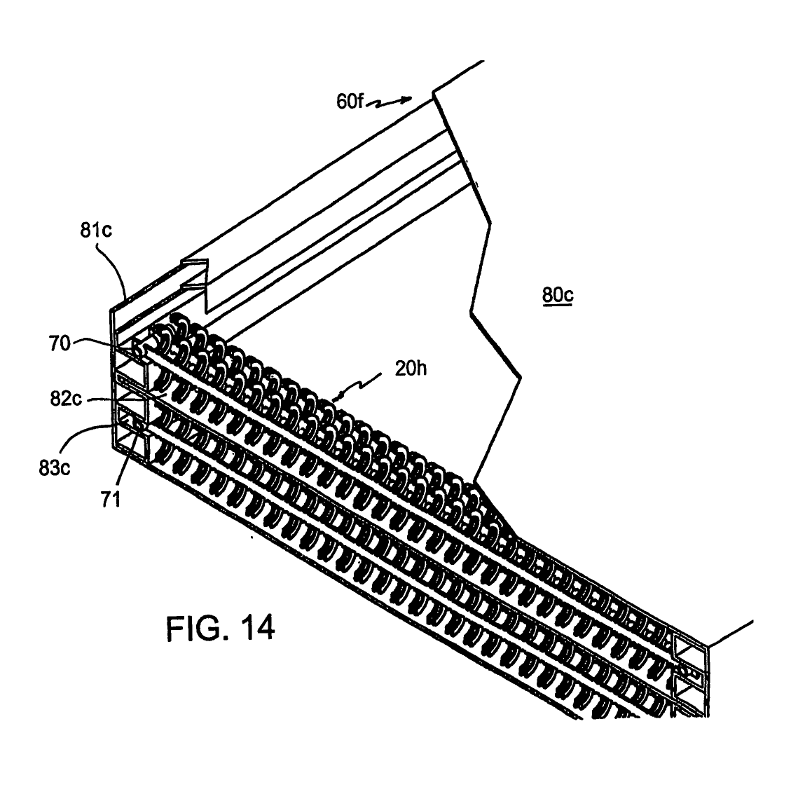

The cartridge embodiments 60e, 60f shown in FIGS. 13 and 14 further includes shelves 88a, 88b which separate the hollow interiors of the cartridges 80a, 80b into the layers of binding strips 20h. In the embodiment of FIG. 13, the shelves 88a, 88b include guides 89 which extend generally at a normal angle to the shelves. These guides 89 are positioned between the fingers of the binding strips 20h to facilitate maintaining the layers of strips 20h in the desired position and smooth movement of the strips 20h from the cartridge 60e. Here, the guides 89 are formed by a simple bending of the shelves 88a, 88b themselves. The guides 89 may alternately be formed by pieces that are integrally molded with the shelves 88a, 88b or which are formed separately and then attached thereto.

Such shelves, however, may not be necessary in arrangements where the strips 20h are restrained in position by means of channels 83a, 83b, 83c such as are provided in FIGS. 12-14, so long as the strips 20h themselves are sufficiently rigid, and the arrangement provides adequate support to the strips to prevent their becoming entangled. Similarly, it will be appreciated that the cartridge itself is not confined to a box-like structure. For example, the cartridge may be in the form of a frame-like arrangement which supports the binding strips, but has no walls per se.

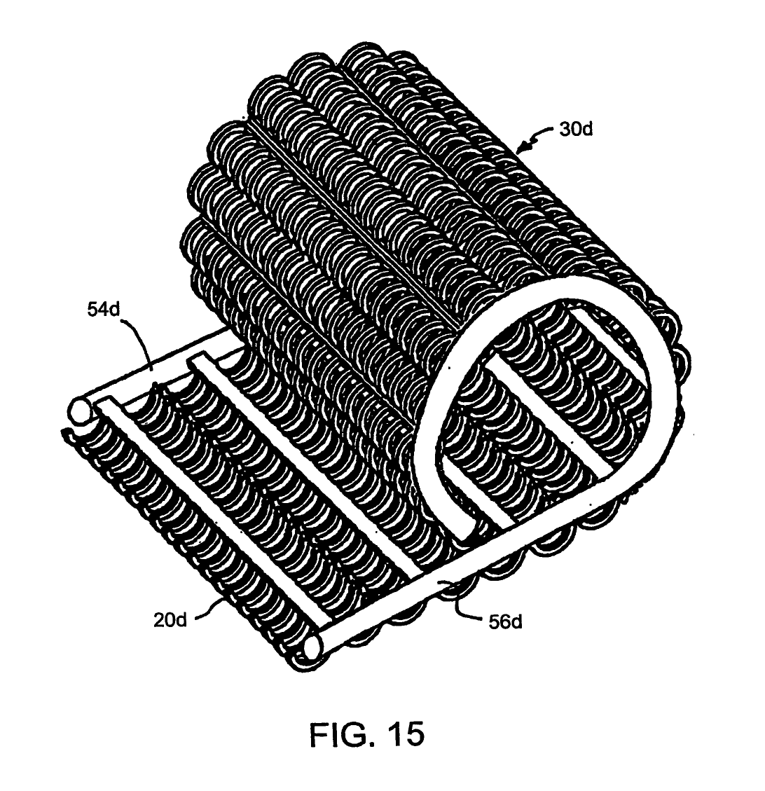

According to yet another embodiment, the parallelly disposed plurality of binding elements may be molded as a continuous length of binding elements 30d, similar to the continuous length illustrated and described with regard to FIGS. 2-7. As shown in FIG. 15, the runners 54d, 56d disposed at opposite longitudinal ends of the individual binding elements 20d provide continuity and connection between the binding elements 20d and the continuous length may be rolled either on itself as shown in FIG. 15, or onto a roller or spool. When molding the continuous plurality of binding elements 30d illustrated in FIG. 15, the individual binding elements 20d may be molded along the continuous runners 54d, 56d in a manner similar to the continuous spine illustrated in FIG. 7. Alternately, the continuous plurality of binding elements 30d may be molded by only partially molding the trailing end of the runner and/or the trailing binding element at the trailing end of a molded length of binding elements, similar to the manner set forth in FIGS. 4-6.

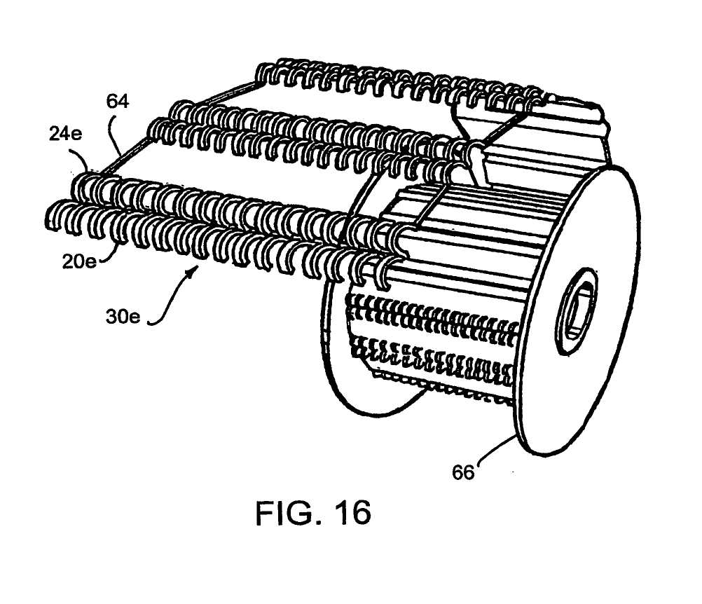

It will be appreciated that the coupling structure may extend between any appropriate portions of the binding elements 20, as, for example, the spines 22 or fingers 24. In the embodiment illustrated in FIG. 16, the runners are the form of a plurality of links 64 that extend between the fingers 24e of adjacent binding elements 20e. While the links 64 are illustrated extending between the outermost pairs of fingers, it will be appreciated that one or more links 64 may alternately be provided that extend between other pairs of fingers, or, in the case of binding strips having single fingers as opposed to pairs, for example, between fingers and spine. The plurality 30e of binding elements 20e so linked may be rolled onto themselves in a method similar to that shown in FIG. 15 or rolled onto a spool like device 66, as shown in FIG. 16. During use, the plurality 30e of binding elements 20e may be unrolled into a machine and the connecting links 64 severed and disposed of.

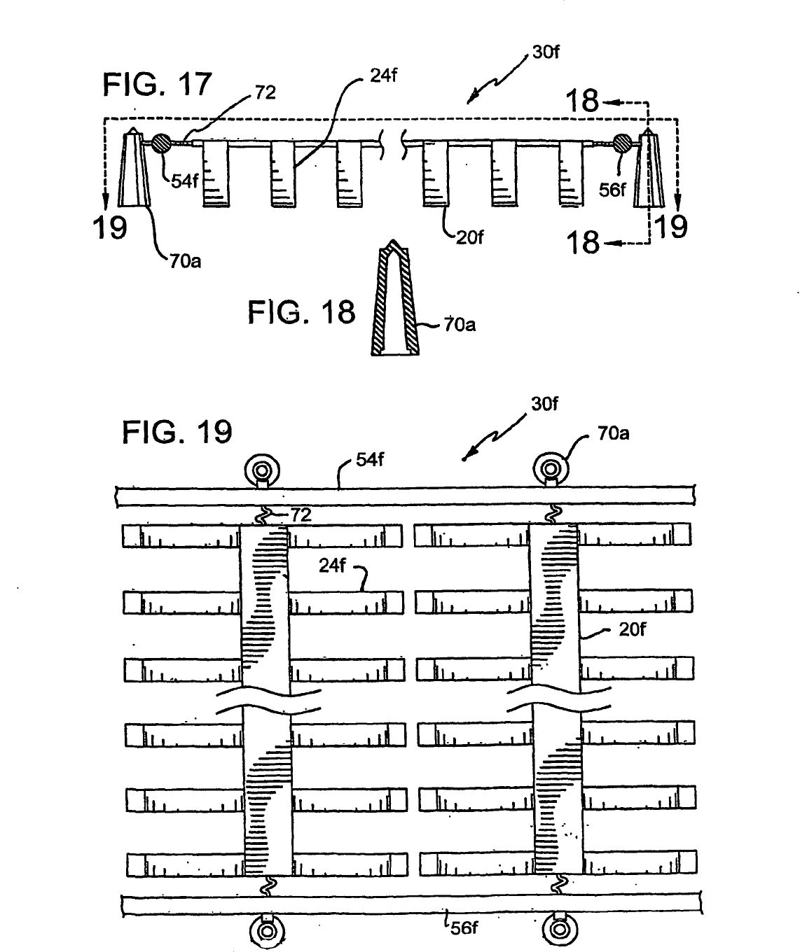

Turning to FIGS. 17-21, according to another feature of the invention, the plurality of binding elements 30f, 30g may be provided with a stacking structure 70a, 70b that facilitates stacking the binding elements 20f, 20g as a part of a plurality 30f, 30g, i.e., in sheets or the like, or individually, i.e., if the runners 54f, 54g, 56f, 56g are cut.

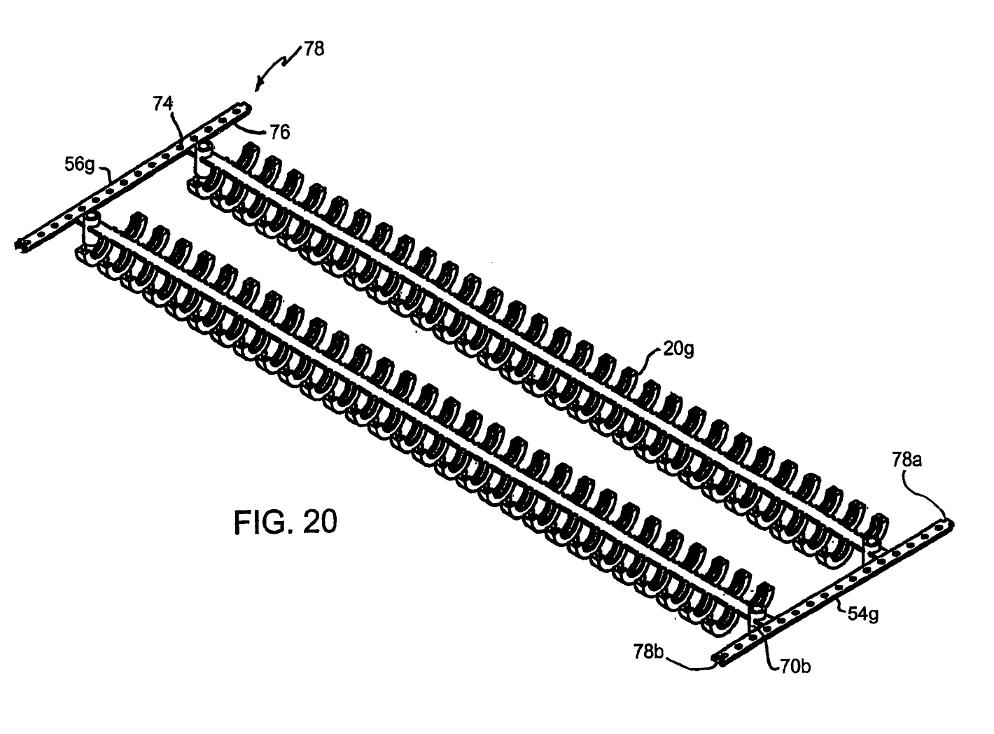

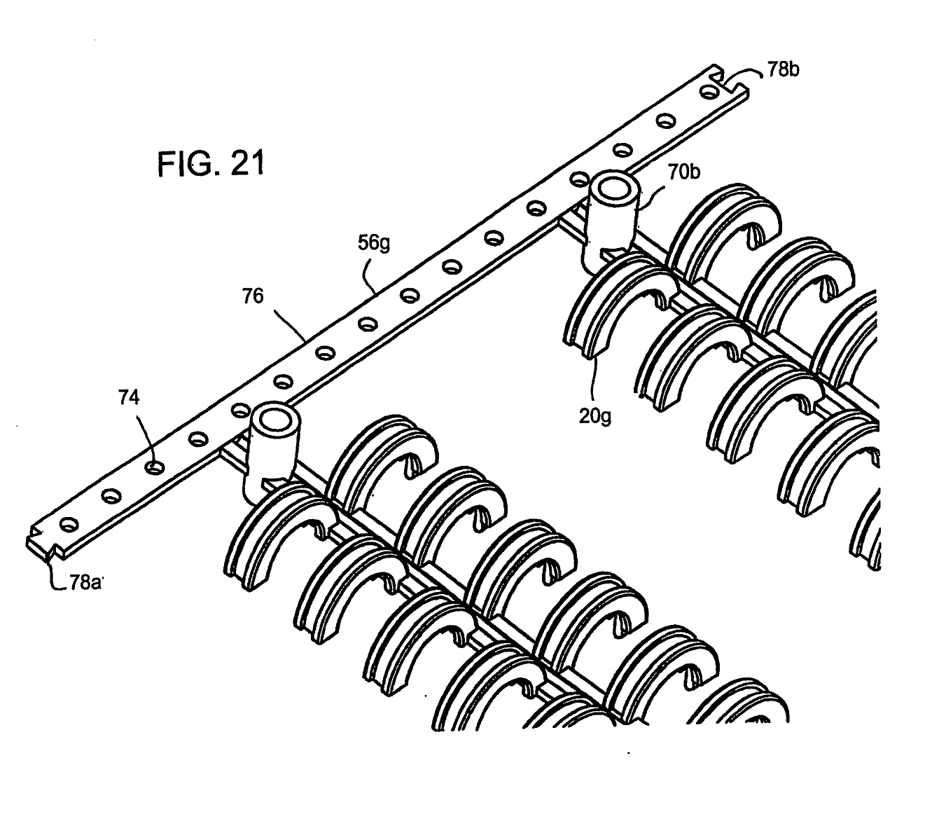

The stacking structures 70a, 70b may be in any appropriate form that facilitates stacking. Various designs for stacking structure 70 are shown, for example, in Application PCT/US0106362. Further, the stacking structure 70b may be disposed inboard the runners 54g, 56g, i.e., between the runners 54g, 56g, and the binding strips 20g themselves, as shown in FIGS. 20-21, for example, or outboard the runners 54f, 56f, i.e., the runners 54f, 56f are disposed between the stacking structure 70a and the binding strips 20f, as shown, for example, in FIGS. 17-19. In this way, either or both the runners 54f, 54g, 56f, 56g or coupling structure and the stacking structure 70a, 70b may be utilized. If only one or the other is utilized, the extraneous structure may be severed prior to use or may merely remain unused in the binding machine. In either case, the coupling structure 54f, 54g, 56f, 56g and the stacking structure 70a, 70b are both preferably severed before, during or after storage and/or an automated handling and binding processes when they are no longer needed or desired. It will be appreciated, however, that a stacking structure may be formed as part of the binding element itself, in which case it need not be severed.

Referring now to FIGS. 20-21, the runners 54g, 56g may include an engagement structure which may be engaged by mechanical means of a binding machine or the like to pull or push the assembly along. In the illustrated embodiment, the engagement structure is in the form of openings 74 therethrough which may be engaged by pins or the like. Those of skill in the art will appreciate that alternate engagement structure may be provided, such as, for example, one or more flanges or the like may protrude from the surface of the runner and may be used to ratchet and advance the runner(s) and the attached plurality of binding elements forward.

A plurality of binding elements may likewise be formed by individually forming one or more binding elements 20g along with one or more runner segments 76. In FIGS. 20 and 21, two binding elements 20g are molded with runner segments 76 disposed at either longitudinal end. In order to couple the runner segments 76 together, the segments 76 are preferably provided with a coupling structure 78, such as the keyed arrangement 78 shown. In the currently preferred form, the keyed arrangement 78 includes a male component 78a which may be received in a female component 78b of another runner segment 76. Alternately, a single runner segment may be provided with two male or two female components which may engage a runner segment having the complimentary configuration. It will be appreciated by those of skill in the art that the runner segments may include an alternate coupling structure or may be coupled together by an alternate method such as ultrasonic welding or applying an adhesive.

It will be appreciated that variances that often occur in the strips themselves and/or in the tools that handle the plurality of strips within a binding machine. These variances may affect the interaction between the plurality of strips and the tools. For example, shrinkage during the curing of the plastic forming the plurality of strips may result in a poor engagement of the coupling structure or stacking structure. Additionally, wear or a build-up of tolerances in the tools or in the mechanisms moving the tools may result in a certain amount of slop or looseness that may be disadvantageous in handling of the strips.

In order to minimize or eliminate the effect of such variances, the plurality of strips 30f preferably includes a flexible connecting structure or flexible connector 72 between the individual strips and the coupling structure or stacking structure. In its preferred embodiment, the flexible connector 72 has a serpentine shape, and, in particular, the form of a small, flat spring 72 shown in FIGS. 17 and 19. In use, the spring or flexible connector 72 allows the runners 54f, 56f to flex toward or away from the strips 20f to adjust to the tool used to carry the runners 54f, 56f within a machine.

While the flexible connector 72 is illustrated in the binding element design of FIGS. 17-19, it will be appreciated that the flexible connector 72 is similarly useful in any structure where some flexibility between the product and the coupling structure is desired. For example, the flexible connector would likewise be applicable to designs such as those illustrated in FIGS. 8, 9, 15, and 16 or in the assemblies utilizing stacking structure 70 alone, such as those illustrated in FIGS. 11A-14 and as already disclosed and shown in Application PCT/US01/06362. The coupling structure itself may take the form of a flexible connector. For example, the links 64 of FIG. 16 may have a spring-like structure.

The small, flat spring 72 shown in FIGS. 17 and 19 is particularly well suited to the illustrated binding strip 20f design because the entire structure may be molded in a two-part mold with no moving cores. It will be appreciated, however, that this flexible connector may be of an alternate design so long as it allows for a certain amount of flexibility between the binding strips and the runner. For example, a coiled spring may be provided. Alternately, the flexible connector may be a simple link that is essentially molded at other than a right angle to the binding strip 20f such that the link may move toward a right angle position as forces are exerted to move the coupling structure (such as the runners 54f, 56f) away from the binding elements 20f, the link or a portion thereof acting as a living hinge between the runner or stacking structure and the binding strip. Conversely, if forces were applied to move the runner 54f, 56f toward the binding elements 20f, the link would move to a smaller angle.

In summary, the invention provides various arrangements for supplying a plurality of binding elements to an automated machine for automated binding. The binding elements may be disposed end-to-end in a continuous length, or in a parallel arrangement coupled by continuous runners at either end of the strip. The binding elements may be fed directly into a binding machine or fed into a binding machine by way of a delivery structure such as a box or the like. When fed by way of a delivery structure, the binding elements may be separate from one another or bound in sheets with runners at opposite longitudinal ends of the spine. The plurality of binding elements may also include stacking structure which facilitates the stacking of binding elements while either coupled together by the coupling structure, or when the coupling structure is severed therefrom, or when the coupling structure is cut to provide individual binding elements with the coupling structure attached. Before, during or after the storage, handling and/or binding processes, any coupling structure between the strips and/or the stacking structure may be severed to separate the strips. The plurality of binding strips may also include a flexible connector, such as a spring or the like, between the strips and the coupling and/or stacking structure. The additional flexibility provided by the flexible connector facilitates interaction of the coupling structure and/or stacking structure with handling and binding machines or apparatuses. In this way, pluralities of binding elements may be economically manufactured and efficiently delivered to automated machines to facilitate high volume binding processes.

While this invention has been described with an emphasis upon preferred embodiments, variations of the preferred embodiments can be used, and it is intended that the invention can be practiced otherwise than as specifically described herein. Accordingly, this invention includes all modifications encompassed within the spirit and scope of the invention as defined by the following claims. For example, various aspects of the invention may be practiced simultaneously, such as a plurality of binding elements with stacking structures, flexible connectors and runners disposed in a cartridge.

All of the references cited herein, including patents, patent applications, and publications, are hereby incorporated in their entireties by reference.

We claim as our invention:

1. A plurality of binding elements for binding stacks of perforated sheets, said binding elements being deliverable to an automated machine for feeding and/or handling said elements, and/or binding said binding elements into said stacks, said plurality of binding elements comprising
at least two binding elements, each said binding element comprising
an elongated spine,
a plurality of fingers extending from said spine, said plurality of fingers being adapted to form a plurality of closed loops and spaced to be received in perforations of said sheets, and
at least one runner, said runner coupling the at least two binding elements together in a predetermined adjacent spacial relationship for delivery to said automated machine,
said binding elements and said runner adapted to be fed to said automated machine, said runners being adapted to be severed from said binding elements.

2. The plurality of binding elements of claim 1 wherein the runner extends between fingers of the respective at least two one binding elements and at least one of the spine or fingers of a second binding elements to couple the binding elements together.

3. The plurality of binding elements of claim 1 wherein the runner extends between the spines of the respective at least two binding elements.

4. The plurality of binding elements of claim 1 wherein the at least two binding elements and the at least one runner form a sheet.

5. The plurality of binding elements of claim 1 wherein the at least two binding elements are disposed in a roll.

6. The plurality of binding elements of claim 1 further comprising a spool, the at least two binding elements being rolled up onto the spool.

7. The plurality of binding elements of claim 1 further comprising a cartridge, the at least two binding elements being disposed within the cartridge for delivery to said automated machine.

8. The plurality of binding elements of claim 1 further comprising at least one stacking structure coupled to at least one of the at least two binding elements, said stacking structure being unitarily formed of the polymeric material with the at least two binding elements and the at least one runner.

9. The plurality of binding elements of claim 8 wherein said stacking structure is disposed and sized such that the stacking structure of the at least one of the at least two binding elements to which the stacking structure is coupled abuts a stacking structure of a second binding element to substantially maintain said binding elements in a second given spatial relationship.

10. The plurality of binding elements of claim 8 wherein the stacking structure is disposed between the runner and said at least one of the at least two binding elements.

11. The plurality of binding elements of claim 8 wherein runner is disposed between the stacking structure and said at least one of the at least two binding elements.

12. The plurality of binding elements of claim 1 wherein said at least one runner comprises at least two elongated runners, said binding elements having opposite ends, the at least two runners being coupled to the binding elements at said opposite ends.

13. The plurality of binding elements of claim 1 wherein said at least one runner comprises a plurality of links disposed between adjacently disposed binding elements.

14. The plurality of binding elements of claim 1 further comprising at least one flexible connector, said flexible connector being disposed between said at least one runner and said binding elements and being unitarily formed with the binding elements and the runner.

15. The plurality of binding elements of claim 14 wherein the flexible connector has a serpentine shape.

16. The plurality of binding elements of claim 14 wherein the flexible connector comprises a living hinge.

17. The plurality of binding elements of claim 1 wherein the at least one runner comprises a metallic element.

18. The plurality of binding elements of claim 1 wherein the at least one runner comprises a fabric element.

19. The plurality of binding elements of claim 1 wherein the at least one runner comprises plastic.

20. The plurality of binding elements of claim 1 wherein the at least one runner is of a discrete length with opposed ends, said opposed ends comprising a coupling structure adapted to cooperate with a coupling structure of another discrete length of runner.

21. The plurality of binding elements of claim 20 further comprising an engagement structure adapted to cooperate with said binding machine.

22. The plurality of binding elements of claim 21 wherein the engagement structure comprises at least one opening extending through said runner.

23. A plurality of binding elements for binding stacks of perforated sheets, said binding elements being deliverable to an automated machine for feeding and/or handling said elements, and/or binding said binding elements into said stacks, said plurality of binding elements comprising
at least two binding elements, each said binding element comprising
an elongated spine,
a plurality of fingers extending from said spine, said plurality of fingers being adapted to form a plurality of closed loops and spaced to be received in perforations of said sheets, and
a cartridge having a hollow inside chamber cooperating with a discharge opening, said cartridge being adapted to cooperate with said automated machine, said at least two binding elements being disposed within said cartridge for delivery to said automated machine.

24. The plurality of binding elements of claim 23 further comprising at least one runner, said runner coupling the at least two binding elements together in a predetermined spacial relationship for delivery to said automated machine, said binding elements and said runner being disposed within said cartridge for delivery to said automated machine.

25. The plurality of binding elements of claim 24 wherein the cartridge comprises at least one channel, said channel receiving said runner to maintain said binding elements in a fixed relative spacial relationship.

26. The plurality of binding elements of claim 23 further comprising at least one stacking structure coupled to each binding element, said stacking structure being unitarily formed of the polymeric material with said binding element, said stacking structure being disposed and sized such that the stacking structure of adjacent binding elements abut to substantially maintain said adjacent binding elements in a given spatial relationship.

27. The plurality of binding elements of claim 26 wherein the cartridge comprises at least one channel, said channel receiving said stacking structure to maintain said binding elements in a fixed relative spacial relationship.

28. The plurality of binding elements of claim 23 wherein said binding elements each include a protrusion and the cartridge comprises at least one channel, said channel receiving said protrusion to maintain said binding elements in a fixed relative spacial relationship.

29. The plurality of binding elements of claim 23 wherein said cartridge has a side, and said side comprises an elongated opening.

30. The plurality of binding elements of claim 26 wherein said cartridge has a side, and said side comprises an elongated access opening, said elongated access opening cooperating with said channel whereby said binding machine may engage said protrusion.

31. The plurality of binding elements of claim 23 further comprising a drive bar, said drive bar being disposed within said cartridge, adjacent at least one of said binding elements such that movement of said drive bar toward said discharge opening advances said at least one of said binding elements toward said discharge opening.

32. The plurality of binding elements of claim 31 wherein said drive bar is biased toward said discharge opening such that said drive bar inhibits movement of the binding elements away from said discharge opening within said cartridge.

33. The plurality of binding elements of claim 31 wherein said cartridge and said drive bar comprise a ratcheting arrangement whereby movement of said drive bar toward said discharge opening inhibits movement of said binding elements away from said discharge opening within said cartridge.

34. The plurality of binding elements of claim 31 wherein at least one of the cartridge or the drive bar comprises a frictional element, said frictional element adapted to inhibit movement of said drive bar within said cartridge away from said discharge opening.

35. The plurality of binding elements of claim 23 further comprising a frictional element disposed within said cartridge to inhibit movement of said binding elements within said cartridge away from said discharge opening.

36. The plurality of binding elements of claim 35 wherein at least one of the cartridge or the binding elements comprises said frictional element.

37. The plurality of binding elements of claim 28 wherein at least one of the channel or the protrusion comprises a frictional element, said frictional element inhibiting the movement of said binding elements away from said discharge opening.

38. The plurality of binding elements of claim 23 further comprising a ratchet, said ratchet inhibiting movement of said binding elements within said cartridge away from said discharge opening.

39. The plurality of binding elements of claim 23 wherein said binding elements are biased toward said discharge opening.

40. The plurality of binding elements of claim 23 wherein said cartridge comprises at least one shelf.

41. The plurality of binding elements of claim 40 wherein said shelf comprises at least one guide adapted to be disposed between at least two of the plurality of fingers.

42. The plurality of binding elements of claim 23 wherein said cartridge further comprising at least one surface adapted to at least partially obstruct said discharge opening when said cartridge is not disposed in cooperation with said binding machine.

43. The plurality of binding elements of claim 42 wherein said at least one surface comprises at least one door.

44. The plurality of binding elements of claim 43 wherein said at least one door is hingedly coupled to said cartridge.

45. A plurality of binding elements for binding stacks of perforated sheets, said binding elements being deliverable to an automated machine for feeding and/or handling said elements, and/or binding said binding elements into said stacks, said plurality of binding elements comprising
at least two binding elements, each said binding element comprising an elongated spine,
a cartridge having a hollow inside chamber cooperating with a discharge opening, said cartridge being adapted to cooperate with said automated machine, said at least two binding elements being disposed within said cartridge for delivery to said automated machine
a drive bar, said drive bar being disposed within said cartridge, adjacent at least one of said binding elements such that movement of said drive bar toward said discharge opening advances said at least one of said binding elements toward said discharge opening.

46. The plurality of binding elements of claim 45 wherein said drive bar is biased toward said discharge opening such that said drive bar inhibits movement of the binding elements away from said discharge opening within said cartridge.

47. The plurality of binding elements of claim 45 wherein said cartridge and said drive bar comprise a ratcheting arrangement whereby movement of said drive bar toward said discharge opening inhibits movement of said binding elements away from said discharge opening within said cartridge.

48. The plurality of binding elements of claim 45 wherein at least one of the channel or the drive bar comprises a frictional element, said frictional element adapted to inhibit movement of said drive bar within said cartridge away from said discharge opening.

49. The plurality of binding elements of claim 45 further comprising at least one stacking structure coupled to each binding element, said stacking structure being unitarily formed of the polymeric material with said binding element, said stacking structure being disposed and sized such that the stacking structure of adjacent binding elements abut to substantially maintain said adjacent binding elements in a given spatial relationship.

50. The plurality of binding elements of claim 49 wherein the cartridge comprises at least one channel, said channel receiving said stacking structure to maintain said binding elements in a fixed relative spacial relationship.

51. The plurality of binding elements of claim 45 wherein said binding elements each include a protrusion and the cartridge comprises at least one channel, said channel receiving said protrusion to maintain said binding elements in a fixed relative spacial relationship.

52. The plurality of binding elements of claim 45 wherein said cartridge has a side, and said side comprises an elongated access opening, said elongated access opening cooperating with said channel whereby said binding machine may engage said drive bar.

53. The plurality of binding elements of claim 45 wherein said cartridge further comprising at least one surface adapted to at least partially obstruct said discharge opening when said cartridge is not disposed in cooperation with said binding machine.

54. The plurality of binding elements of claim 53 wherein said at least one surface comprises at least one door.

55. The plurality of binding elements of claim 54 wherein said at least one door is hingedly coupled to said cartridge.

56. A plurality of binding elements for binding stacks of perforated sheets, said binding elements being deliverable to an automated machine for feeding and/or handling said elements, cutting and/or binding said binding elements into said stacks, each said binding element having a desired length, said plurality of binding elements comprising an elongated spine, said elongated spine having a length equal to at least the sum of the lengths of said binding elements, a plurality of fingers extending from said spine, said plurality of fingers being adapted to form a plurality of closed loops and spaced to be received in perforations of said sheets, said spine and plurality of fingers being unitarily formed, said plurality of binding elements being delivery to said automated machine to cut individual binding elements to said desired length.

57. The plurality of binding elements of claim 56 wherein the length of said elongated spine is at least 2 feet.

58. The plurality of binding elements of claim 56 wherein the elongated spine is rolled up lengthwise to roll the plurality of binding elements.

59. The plurality of binding elements of claim 58 further comprising a spool, said elongated spine being rolled up along said spool.

60. The plurality of binding elements of claim 56 wherein the spine includes an elongated length of cord.

61. The plurality of binding elements of claim 60 wherein the spine includes an elongated length of wire.

62. The plurality of binding elements of claim 56 wherein the spine includes an elongated length of a polymeric material from which said fingers extend.

63. A plurality of elements for delivery to an automated machine for performing an automated operation utilizing said elements, said plurality of elements comprising:
at least two elements,
at least one runner, and
at least one flexible connector, said flexible connector being disposed between said at least one runner and said elements, said runner coupling the elements together in a predetermined adjacent spacial relationship for delivery to said automated machine, said elements, said runner, and said flexible connector being unitarily formed, said flexible connector providing sufficient flexibility in the spacial relationship to allow the runner and the elements to move toward or away from one another.

64. The plurality of elements of claim 63 wherein said runner and said flexible connector are severable in said automated operation.

65. The plurality of elements of claim 63 wherein said flexible connector has a serpentine structure.

66. The plurality of elements of claim 63 wherein said flexible connector is a spring.

67. The plurality of elements of claim 63 wherein the flexible connector acts as a living hinge.

68. A plurality of binding elements for binding stacks of perforated sheets, said plurality of binding elements being deliverable to an automated machine for performing an automated process on said stacks and said automated binding elements, each binding element comprising:
an elongated spine,
a plurality of fingers extending from said spine and adapted to form a plurality of closed loops said fingers being spaced to be received in perforations of said sheets,
at least one stacking structure disposed and sized such that the stacking structure of a first said binding element abuts a stacking structure of a second said binding element to substantially maintain said binding elements in a predetermined adjacent spacial relationship for delivery to said automated machine and
at least one flexible connector, said flexible connector being disposed between said at least one stacking structure and said element, said element, said stacking structure, and said flexible connector being unitarily formed.

69. The plurality of elements of claim 68 wherein said stacking structure and said flexible connector are severable in said automated operation.

70. The plurality of elements of claim 68 wherein said flexible connector has a serpentine structure.

71. The plurality of elements of claim 68 wherein said flexible connector is a spring.

72. The plurality of elements of claim 68 wherein the flexible connector has an area of reduced cross-section which acts as a living hinge.

73. A method of molding a plurality of plastic binding elements for binding stacks of perforated sheets, said binding elements being deliverable to an automated machine for feeding and/or handling said elements, and/or binding said stacks, said plurality of binding elements comprising at least two binding elements, each said binding element comprising an elongated spine and a plurality of fingers extending from said spine, said plurality of fingers being adapted to form a plurality of closed loops and spaced to be received in perforations of said sheets, said plurality of binding elements further comprising at least one coupling structure, said coupling structure maintaining the binding elements in a predetermined spacial relationship for delivery to said automated machine, said method including the steps of
integrally molding a first at least one binding element with said at least one coupling structure in a mold cavity,
removing said molded first at least one binding element and at least one coupling structure from said mold cavity,
advancing at least a portion of said molded first at least one binding element or at least one coupling structure to a position adjacent said mold cavity or a cavity of another mold,
integrally molding a second at least one binding element and at least one coupling structure in said mold cavity or said cavity of another mold to said first at least one binding element and at least one coupling structure such that the first and second at least one binding element and at least one coupling structure form a single structure.

74. The method of molding of claim 73 wherein the coupling structure is in the form of at least one runner, and wherein the step of advancing comprises the step of advancing the runner to a position wherein a portion of the molded runner is disposed in said cavity.

75. The method of molding of claim 74 wherein the at least one runner comprises a preformed elongated length, and said integrally molding steps comprise the steps of placing said preformed elongated length in the mold and molding to said preformed elongated length.

76. The method of molding of claim 75 wherein the preformed elongated length comprises a wire.

77. The method of molding of claim 75 wherein the preformed elongated length comprises a cord.

78. The method of molding of claim 75 wherein the preformed elongated length comprises a polymeric elongated length.

79. A method of molding a plurality of plastic binding elements for binding stacks of perforated sheets, said plurality comprising a single elongated binding element assembly being deliverable to an automated machine for feeding and/or handling said elements, and/or binding said stacks, which binding element assembly is adapted to be cut to desired lengths to form said plurality of plastic binding elements, said binding element assembly comprising an elongated spine and a plurality of fingers extending from said spine, said plurality of fingers being adapted to form a plurality of closed loops and spaced to be received in perforations of said sheets, said method including the steps of
integrally molding a first length of said binding element assembly having a lead end and a trailing end in a mold cavity,
removing said molded first length of said binding element assembly from said mold cavity,
advancing at least a portion of said molded first length of said binding element assembly to a position with the trailing end adjacent or within said mold cavity or a cavity of another mold,
integrally molding a second length of said binding element assembly in said mold cavity or said cavity of another mold to said first length of binding element assembly such that the first and second lengths of binding element assembly form a single structure.

80. The method of molding of claim 79 wherein the spine comprises a preformed elongated length, and said integrally molding steps comprise the steps of placing said preformed elongated length in the mold and molding to said preformed elongated length.

81. The method of molding of claim 80 wherein the preformed elongated length comprises a wire.

82. The method of molding of claim 80 wherein the preformed elongated length comprises a cord.

83. The method of molding of claim 80 wherein the preformed elongated length comprises a polymeric elongated length.

84. The method of molding of claim 79 wherein said step of integrally molding a first length of binding element assembly comprises the step of integrally molding only a portion of said trailing end, said step of advancing includes the step of positioning said portion of said trailing end in said mold cavity or said cavity of another mold, and said step of integrally molding a second length of binding element assembly comprises the step of integrally molding a remainder of said trailing end.

85. The method of molding of claim 84 wherein the step of integrally molding only a portion of said trailing end comprises the step of molding said trailing end with an engaging structure.

86. A plurality of binding elements for binding stacks of perforated sheets, said binding elements being deliverable to an automated machine for feeding and/or handling said elements, and/or binding said stacks, said plurality of binding elements comprising
at least two binding elements, each said binding element comprising
an elongated spine,
a plurality of fingers extending from said spine, said plurality of fingers being adapted to form a plurality of closed loops and spaced to be received in perforations of said sheets, and
at least one coupling structure, said coupling structure maintaining the binding elements in a predetermined spacial relationship for delivery to said automated machine, said binding elements.

87. The plurality of binding elements of claim 86 wherein the at least one coupling structure comprises at least one elongated runner coupling the at least two binding elements together, said at least two binding elements and said at least one runner being unitarily formed of a polymeric material.

88. The plurality of binding elements of claim 87 wherein the at least one runner includes a cord.

89. The plurality of binding elements of claim 87 wherein the at least two binding elements and the at least one elongated runner are rolled up for delivery to said automated machine.

90. The plurality of binding elements of claim 89 further comprising a spool, said at least two binding elements and said at least one elongated runner are rolled around said spool for delivery to said automated machine.

91. The plurality of binding elements of claim 87 wherein the at least two binding elements and the at least one elongated runner are disposed in a sheet.

92. The plurality of binding elements of claim 87 further comprising a hollow cartridge, said at least two binding elements and the at least one elongated runner being disposed in said cartridge for delivery to said automated machine.

93. The plurality of binding elements of claim 87 further comprising at least one flexible connector, said flexible connector being disposed between at least one of said at least two binding elements and said at least one runner, said flexible connector being unitarily formed with said at least two binding elements and said runner, said flexible connector providing sufficient flexibility in the spacial relationship to allow the runner to move toward or away from said at least one of said at least two binding elements.

94. The plurality of binding elements of claim 87 further comprising at least one stacking structure disposed and sized and disposed such that the stacking structure of a first said binding element may abut a stacking structure of a second said binding element to substantially maintain said binding elements in a predetermined adjacent spacial relationship for delivery to said automated machine, said at least one stacking structure being unitarily formed with said at least two binding elements and said runner.

95. The plurality of binding elements of 86 wherein the at least one coupling structure is at least one link extending between adjacent said at least two binding elements, said at least one link and said at least two binding elements being unitarily formed of a polymeric material.

96. The plurality of binding elements of claim 86 further comprising a hollow cartridge adapted to cooperate with said automated binding machine, said at least two binding elements being disposed in said cartridge for delivery to said automated machine.

97. The plurality of binding elements of claim 96 further comprising at least two stacking structures disposed and sized such that the stacking structure of a first said binding element may abut a stacking structure of a second said binding element to substantially maintain said binding elements in a predetermined adjacent spacial relationship for delivery to said automated machine.

98. The plurality of binding elements of claim 96 wherein said plurality of binding elements comprising an elongated spine, said elongated spine having a length equal to at least the sum of the lengths of said binding elements, a plurality of fingers extending from said spine, said plurality of fingers being adapted to form a plurality of closed loops and spaced to be received in perforations of said sheets, said spine and plurality of fingers being unitarily formed of a polymeric material, said elongated spine being rolled into a roll and disposed in said cartridge for delivery to said automated machine to cut individual binding elements to said desired length.

99. The plurality of binding elements of claim 86 wherein said plurality of binding elements comprising an elongated spine, said elongated spine having a length equal to at least the sum of the lengths of said binding elements, a plurality of fingers extending from said spine, said plurality of fingers being adapted to form a closed loop and spaced to be received in perforations of said sheets, said spine and plurality of fingers being unitarily formed of a polymeric material, said elongated spine being rolled into a roll for delivery to said automated machine to cut individual binding elements to said desired length.
